(19) United States
(12) Patent Application Publication
(10) Pub. No.: US 2026/0110549 A1
(43) Pub. Date: Apr. 23, 2026

(54) NAVIGATION DATABASE SYNCHRONIZATION

(71) Applicant: Honeywell International Inc., Charlotte, NC (US)

(72) Inventors: Kalimulla Khan, Bangalore (IN); Subhransu Sahoo, Bengaluru (IN); Srilakshmi Kurudi, Bangalore (IN); Gaurav Soni, Bangalore (IN); Sai Keshav Gaba, Bangalore (IN); Gururaj Venkataramana, Bangalore (IN); Harsh Ladani, Bangaluru (IN)

(21) Appl. No.: 18/924,610

(22) Filed: Oct. 23, 2024

(51) Int. Cl. G01C 21/00

(52) U.S. Cl. CPC G01C 21/387

(57) ABSTRACT

A flight analytics system may receive, from a flight recorder of an aircraft, flight data corresponding to one or more routes flown by the aircraft. The flight analytics system may obtain, based on a downlink message sent by the aircraft in-flight, version information of a first navigation database (NavDB) used in-flight by a flight management system of the aircraft while flying the one or more routes. The flight analytics system may determine, based on the version information of the first NavDB, a second NavDB that matches the first NavDB. The flight analytics system may perform, using the second NavDB, flight data analysis on the flight data. The flight analytics system may output, based on the flight data analysis, flight analytics data for the one or more routes flown by the aircraft.

### TECHNICAL FIELD

This disclosure relates to performing flight data analysis of aircrafts.

### BACKGROUND

A Navigational Database (NavDB) contains information regarding airports, runways, flight arrival and flight departure procedures, airways, and the like that are used for flight planning and navigation. The Flight Management System (FMS) of an aircraft may use a Navigational Database (NavDB) to analyze flight routes, plan paths, and ensure compliance with required navigation performance standards. For example, the FMS of an aircraft may use the NavDB to create a flight plan (FPLN) and to compute the trajectory of the aircraft for navigation and guidance of the aircraft along a planned route.

### SUMMARY

In general, aspects of this disclosure are directed to determining the Navigation Database (NavDB) used in-flight by an aircraft to fly one or more routes. A flight analytics system may perform flight analytics analysis of the one or more routes flown by the aircraft using a NavDB that matches the NavDB used by the aircraft to perform various flight planning tasks for the one or more routes.

A flight analytics system may use a NavDB to perform Standard Instrument Departure/Standard Terminal Arrival Routes (SID/STAR) analysis, runway detection analysis, Required Navigation Performance (RNP) analysis, and/or analysis of shortcut flight plans (FPLNs), and the like. Using a NavDB to perform flight data analysis of a flight flown by an aircraft that does not match the NavDB used by the aircraft during that flight may lead to errors in the flight data analysis of the flight.

In accordance with aspects of this disclosure, a flight analytics system that performs flight data analysis of a route flown by an aircraft may obtain version information of a NavDB that is used by the aircraft to perform flight planning tasks for the route. The aircraft may, in response to having its NavDB updated, send a message that specifies the version information of its NavDB to a ground station. The flight analytics system may obtain the version information of the aircraft's NavDB from the ground station and may retrieve, based on the version information of the aircraft's NavDB, a NavDB that matches the aircraft's NavDB. The flight analytics system may therefore use the NavDB that matches the aircraft's NavDB to perform flight data analysis of the route flown by the aircraft.

The techniques of this disclosure may provide certain technical advantages. By obtaining version information of a NavDB that is used in-flight by an aircraft, the techniques of this disclosure enable a flight analytics system to use, for the purposes of performing flight data analysis of a flight flown by the aircraft, a NavDB that matches the NavDB used in-flight by the aircraft. Using a NavDB that matches the NavDB used in-flight by an aircraft to perform flight data analysis of a flight flown by the aircraft may increase the accuracy of such flight data analysis, thereby improving the functionality of the flight analytics system.

Further, by having the flight management system of the aircraft send, to a ground station, a downlink message that specifies the version information of its NavDB in response to having its NavDB updated, and by the flight analytics system communicating with the ground station to obtain the version information of the NavDB sent by the aircraft, the techniques may not require any user intervention, such as a user manually recording the version information of the aircraft's NavDB and then inputting the version information into the flight analytics system. Such manual recording may be susceptible to human errors, which may be eliminated by the aircraft automatically sending a downlink message that specifies the version information of its NavDB in response to having its NavDB updated. Such manual recording may also not be practical for high volumes of data.

In some aspects, the techniques described herein relate to a computer-implemented method including: receiving, from a flight recorder of an aircraft and by a computing device executing a flight analytics system, flight data corresponding to one or more routes flown by the aircraft; obtaining, by the computing device executing the flight analytics system and based on a downlink message sent by the aircraft in-flight, version information of a first navigation database (NavDB) used in-flight by a flight management system of the aircraft while flying the one or more routes; determining, by the computing device executing the flight analytics system and based on the version information of the first NavDB, a second NavDB that matches the first NavDB; performing, by the computing device executing the flight analytics system and using the second NavDB, flight data analysis on the flight data; and outputting, by the computing device executing the flight analytics system and based on the flight data analysis, flight analytics data for the one or more routes flown by the aircraft.

In some aspects, the techniques described herein relate to a computing system including: memory; and one or more processors communicably coupled to the memory and configured to: receive, from a flight recorder of an aircraft, flight data corresponding to one or more routes flown by the aircraft; obtain, based on a downlink message sent by the aircraft in-flight, version information of a first navigation database (NavDB) used in-flight by a flight management system of the aircraft while flying the one or more routes; determine, based on the version information of the first NavDB, a second NavDB that matches the first NavDB; perform, using the second NavDB, flight data analysis on the flight data; and output, based on the flight data analysis, flight analytics data for the one or more routes flown by the aircraft.

In some aspects, the techniques described herein relate to a non-transitory computer-readable storage medium including instructions, that when executed by one or more processors of a computing system, cause the one or more processors to: receive, from a flight recorder of an aircraft, flight data corresponding to one or more routes flown by the aircraft; obtain, based on a downlink message sent by the aircraft in-flight, version information of a first navigation database (NavDB) used in-flight by a flight management system of the aircraft while flying the one or more routes; determine, based on the version information of the first NavDB, a second NavDB that matches the first NavDB; perform, using the second NavDB, flight data analysis on the flight data; and output, based on the flight data analysis, flight analytics data for the one or more routes flown by the aircraft.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 shows a system for performing flight data analysis in accordance with techniques of this disclosure.

FIG. 2 is a block diagram illustrating an example computing system, in accordance with one or more aspects of the present disclosure.

FIG. 3 shows an example of an avionics system in accordance with techniques of this disclosure.

FIG. 4 is a flowchart illustrating example operations performed by an example flight analytics system, in accordance with one or more aspects of the present disclosure.

### DETAILED DESCRIPTION

In general, aspects of this disclosure are directed to determining the Navigation Database (NavDB) used in-flight by an aircraft and performing flight analytics analysis of routes flown by the aircraft using a NavDB that matches the NavDB used by the aircraft to perform flight planning tasks to fly the routes.

An aircraft uses a NavDB to perform various flight planning tasks for flying routes. The aircraft may also use the NavDB, in-flight to manage navigation, adjust routes, assist with approach and landing, and optimize flight performance. To ensure that NavDBs of aircrafts are regularly updated, government regulations may require an aircraft to update its NavDB according to a specified schedule, such as every 28 days. Different aircrafts and different airlines may use different versions of NavDBs provided by different vendors, and the NavDBs used by different aircrafts may be updated according to different schedules.

Similarly, users may use a flight analytics system to analyze flight data of aircrafts. The flight analytics system may use a NavDB to perform certain types of flight data analysis. For example, the flight analytics system may use a NavDB to perform Standard Instrument Departure/Standard Terminal Arrival Routes (SID/STAR) analysis, runway detection analysis, Required Navigation Performance (RNP) analysis, and/or analysis of shortcut flight plans (FPLNs), and the like.

However, using a NavDB to perform flight data analysis of a flight flown by an aircraft that does not match the NavDB used by the aircraft during that flight may lead to errors in the flight analysis. Such errors may include missing arrival procedures used during the flight, incorrect runway selection in the flight analysis, failure of the RNP analysis, and/or mismatches in legs of shortcuts, and/or missing waypoints for portions of the flight that may result in partial flight analysis. These errors in the flight analysis can lead to loss of confidence in the lateral or route-related flight data analysis performed by the flight analytics system.

In accordance with aspects of this disclosure, a flight analytics system that performs flight data analysis of routes flown by an aircraft may obtain version information of a NavDB that is used in-flight by the aircraft to fly those routes. The flight management system of the aircraft may, in response to having its NavDB updated, send, to a ground station, a downlink message that specifies the version information of its NavDB. The flight analytics system may obtain the version information of the aircraft's NavDB from the ground station and may retrieve, based on the version information of the aircraft's NavDB, a NavDB that matches the aircraft's NavDB. The flight analytics system may therefore use the NavDB that matches the aircraft's NavDB to perform flight data analysis of routes flown by the aircraft.

The techniques of this disclosure may provide certain technical advantages. By obtaining version information of a NavDB that is used in-flight by an aircraft, the techniques of this disclosure enables a flight analytics system to use, for the purposes of performing flight data analysis of a flight flown by the aircraft, a NavDB that matches the NavDB used in-flight by the aircraft. Using a NavDB that matches the NavDB used in-flight by an aircraft to perform flight data analysis of a flight flown by the aircraft may increase the accuracy and reduces the errors of such flight data analysis, thereby improving the functionality of the flight analytics system.

Further, by having the flight management system of the aircraft send, to a ground station, a downlink message that specifies the version information of its NavDB in response to having its NavDB updated, and by the flight analytics system communicating with the ground station to obtain the version information of the NavDB sent by the aircraft, the techniques may not require any user intervention, such as a user manually recording the version information of the aircraft's NavDB and then inputting the version information into the flight analytics system. Such manual recording may be susceptible to human errors, which may be eliminated by the aircraft automatically sending a downlink message that specifies the version information of its NavDB in response to having its NavDB updated. Such manual recording may also not be practical for high volumes of data.

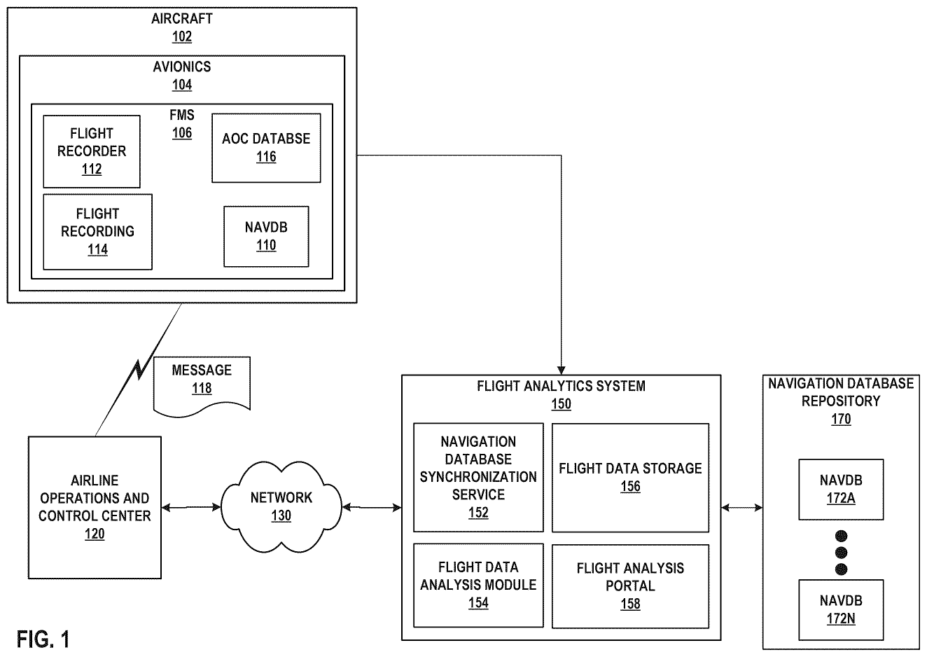

FIG. 1 shows a system for performing flight data analysis in accordance with techniques of this disclosure. In the example of FIG. 1, aircraft 102 includes avionics 104, which are electronic systems used in aircraft 102 for managing safe and efficient operation of aircraft 102. Examples of such electronic systems in avionics 104 may include communication systems, navigation systems (e.g., Global Positioning System components), monitoring instruments, autopilot, radar, cockpit displays, and/or electronic control systems.

Avionics 104 of aircraft 102 includes flight management system (FMS) 106. FMS 106 is an on-board computing device configured to manage and/or automate various flight operations and in-flight functions of aircraft 102. FMS 106 may integrate avionics components and functions, such as navigation, performance optimization, and control interfaces, to assist the flight crew of aircraft 102 in planning, monitoring, and executing the flight plan.

FMS 106 includes NavDB 110, flight recorder 112, flight recording 114, Aeronautical operational control (AOC) database 116. Flight recorder 112 may perform operations described herein using hardware, software, firmware, or a mixture thereof residing in and/or executing at FMS 106. FMS 106 may execute flight recorder 112 with one processor or with multiple processors. In some examples, FMS 106 may execute flight recorder 112 as a virtual machine executing on underlying hardware. Flight recorder 112 may execute as one or more services of an operating system or computing platform or may execute as one or more executable programs at an application layer of a computing platform.

Flight recorder 112 may be configured to record flight data of aircraft 102 and to save the recorded flight data as flight recording 114 stored in FMS 106. In examples where flight recorder 112 is a quick access recorder (QAR), flight recording 114 may be referred to as QAR flight data. Flight recorder 112 may record, in flight recording 114, a wide range of flight data parameters that can be analyzed by flight analytics system 150. The flight data may, for example, be in an Aeronautical Radio, Incorporated (ARINC) 400 series format, such as ARINC 429, or an ARINC 700 series format, such as ARINC 702, 717, or 767. The parameter data may, for example, include a series of words, with each word having an X-bit label and a Y-bit value. The X-bit label identifies a parameter, and the Y-bit value identifies a value for the parameter. In this example, X and Y are positive integer values, such as 16 and 16, respectively, although other values for X and Y may also be used. Examples of parameters include airspeed, altitude, engine revolutions per minute (RPM), temperature, heading, pitch, roll, vertical speed, cabin pressure, fuel flow, and numerous other potential parameters.

Navigation database (NavDB) 110 of FMS 106 may store flight navigation information that is used for route planning, flight execution, and operational efficiency of aircraft 102. A navigational database such as NavDB 110 may include information regarding waypoints and fixes, which are predefined geographical locations, represented by latitude and longitude coordinates, used to define air routes. A navigational database such as NavDB 110 may also include information regarding airways, which may be established flight paths or corridors that aircraft 102 follow between waypoints, and which may be used to calculate efficient routes and to ensure that aircraft 102 flies within regulated airspace corridors. A navigational database such as NavDB 110 may also include information regarding ground-based navigational aids such as VOR (VHF Omnidirectional Range) stations, NDBs (Non-Directional Beacons), ILS (Instrument Landing Systems), and the like.

A navigational database such as NavDB 110 may also include information regarding airports and runways, such as locations, runway configurations, and the like. A navigational database such as NavDB 110 may also include information regarding standardized procedures for arrival and departure, such as Standard Instrument Departures (SIDs), Standard Terminal Arrival Routes (STARs), instrument approach procedures for landing, and the like.

FMS 106 may be periodically updated with a more recent version of a NavDB. For example, FMS 106 may be periodically updated according to federal regulations, such as every 28 days, with a newer version of a NavDB. NavDB 110 may be associated with a version number and Aeronautical Information Regulation And Control (AIRAC) cycle that together form the version information of NavDB 110. Thus, a newer version of a NavDB may periodically be uploaded or otherwise updated, pre-flight, to FMS 106.

AOC database 116 may be a database or other data store that is configured to store aeronautical operational control configuration information for FMS 106. Such configuration information may include conditional logic for FMS 106 to, in response to detecting that FMS 106 has been updated with a new version of a NavDB, send, while aircraft 102 is in-flight, a downlink message 118 to a ground station, such as airline operations and control center 120, that specifies the version information of NavDB 110 in FMS 106.

During a flight of aircraft 102, FMS 106 may, based on the aeronautical operational control configuration information stored in AOC database 116, determine whether FMS 106 has been updated with a newer version of a NavDB. For example, FMS 106 may determine the version information of NavDB 110 (e.g., the version number and the AIRAC cycle of the NavDB 110) in FMS 106 that is currently being used by FMS 106, and may compare the version information of NavDB 110 with the persisted version information of the NavDB that was in use prior to the current flight of aircraft 102 to determine whether FMS 106 has been updated with a new version of a NavDB. FMS 106 may, in response to determining that FMS 106 has been updated with a newer version of a NavDB, in the form of NavDB 110, determine to send, to a ground communication station, a downlink message that specifies the version information of NavDB 110.

Thus, FMS 106 may, in response to aircraft 102 being within communication range of a ground communication station, such as airline operations and control center 120, send downlink message 118 to airline operations and control center 120 that specifies the version information of NavDB 110. As discussed above, the version information of NavDB 110 include a version number and an AIRAC cycle. In some examples, the downlink message 118 may also specify aircraft identification information for aircraft 102, such as an aircraft registration number (also referred to as a tail number) of aircraft 102.

Airline operations and control center 120 may be a central hub responsible for overseeing and managing aspects of an airline's flight operations. Airline operations and control center 120 may manage real-time communication and coordination between the airline's ground personnel and the airline's aircrafts that are in-flight. Airline operations and control center 120 may perform flight monitoring and control of the airline's aircrafts that are in-flight, including performing monitoring of the real-time status of the airline's aircrafts in-flight, such as the aircrafts'positions, altitudes, speeds, and fuel levels.

Airline operations and control center 120 may also be or include one or more ground communication stations that communicates with the airline's aircrafts in-flight. Airline operations and control center 120 may maintain communications with aircraft via data links satellite communication systems, and/or radio links with the aircrafts, and may receive messages, such as downlink messages (e.g., downlink message 118), from aircrafts within communication range of airline operations and control center 120, such as from aircraft 102.

The ground communication stations of airline operations and control center may receive data, such as downlink message 118, via any suitable communication channel. Examples of such communication channels include VHF (Very High Frequency) and HF (High Frequency) radios, ACARS (Aircraft Communication Addressing and Reporting System), satellite communication, ADS-B (Automatic Dependent Surveillance-Broadcast).

Downlink message 118 may, for example, be transmitted by FMS 106 using an aircraft communications addressing and reporting system (ACARS) configured to send operational messages, flight information, and system status updates to airline operations and control center 120. Downlink message 118 may utilize a standardized format, such as fixed-length fields for message types, addresses, and content. Downlink message 118 may, for example, include a message header, message body, and message footer. The message header may, for example, include an address specifying an intended recipient (e.g., airline operations and control center 120) and the sender (e.g., aircraft 102). The message body may, for example, indicate the type of information being transmitted, such as whether the message relates to flight information, operational information, maintenance information, communication, flight dispatch, safety, or other such types, and the message body may also identify data or values for the type of information. The message footer may identify the end of the message.

Flight analytics system 150 may communicate with airline operations and control center 120 via network 130. Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between flight analytics system 150 and airline operations and control center 120. Flight analytics system 150 and airline operations and control center 120 may transmit and receive data across network 130 using any suitable communication techniques. Each of flight analytics system 150 and airline operations and control center 120 may be operatively coupled to network 130 using respective network links, such as Ethernet, Wi-Fi, or any other types of wired and/or wireless network connections.

Flight analytics system 150 may represent any suitable computing system, such as one or more desktop computers, laptop computers, mainframes, servers, cloud computing systems, etc. capable of sending and receiving information both to and from a network. In some examples, flight analytics system 150 may represent cloud computing systems that provide access to their respective services via a cloud.

Flight analytics system 150 includes navigation database synchronization service 152, flight data analysis module 154, flight data storage 156, and flight analysis portal 158. Navigation database synchronization service 152 may be any suitable data store or repository, such as a database, that may be included in flight analytics system 150, and may be configured to store data used by flight analytics system 150 to perform flight data analysis of routes flown by aircrafts.

Navigation database synchronization service 152, flight data analysis module 154 and flight analysis portal 158 may perform operations described herein using hardware, software, firmware, or a mixture thereof residing in and/or executing at flight analytics system 150. Flight analytics system 150 may execute navigation database synchronization service 152, flight data analysis module 154, and flight analysis portal 158 with one processor or with multiple processors. In some examples, flight analytics system 150 may execute navigation database synchronization service 152, flight data analysis module 154, and flight analysis portal 158 as a virtual machine executing on underlying hardware. Navigation database synchronization service 152, flight data analysis module 154, and flight analysis portal 158 may execute as one or more services of an operating system or computing platform or may execute as one or more executable programs at an application layer of a computing platform.

Navigation database synchronization service 152 is configured to obtain version information of the NavDBs used by aircrafts to fly one or more routes, so that flight analytics system 150 may use NavDBs that matches the NavDBs used by the aircrafts to perform flight data analysis of the one or more routes flown by the aircrafts. Navigation database synchronization service 152 may communicate with airline operations and control center 120 via network 130 to monitor for downlink messages (e.g., downlink message 118) received by airline operations and control center 120 from aircrafts that indicate the version information of NavDBs used by the aircrafts. Such downlink messages may indicate both the version information of a NavDB used by an aircraft as well as aircraft identification information (e.g., a tail number) for the aircraft. Airline operations and control center 120 may, in response to receiving a downlink message (e.g., downlink message 118) from an aircraft that indicates the version information of the NavDB used by the aircraft, send an indication of the version information of the NavDB used by the aircraft and an indication of aircraft identification information to navigation database synchronization service 152 via network 130.

In the example of FIG. 1, navigation database synchronization service 152 may communicate with airline operations and control center 120 to monitor for a downlink message from aircraft 102 that specifies the version information of NavDB 110. After airline operations and control center 120 receives a downlink message 118 from aircraft 102 that specifies the version information of NavDB 110 and aircraft identification information for aircraft 102, navigation database synchronization service 152 may receive, from airline operations and control center 120, the version information of NavDB 110 and aircraft identification information for aircraft 102.

Flight analytics system 150 may store, in flight data storage 156, data regarding flights that are being analyzed by flight analytics system 150. For example, flight data storage 156 may store, for each aircraft having flights that are analyzed by flight analytics system 150, an association of the version information of the NavDB used by the aircraft and the aircraft identification information for the aircraft.

In the example of FIG. 1, navigation database synchronization service 152 may, in response to receiving the version information of NavDB 110 and aircraft identification information for aircraft 102, store an association of the version information for NavDB 110 and the aircraft identification information for aircraft 102 in flight data storage 156. For example, navigation database synchronization service 152 may store, in flight data storage 156, the aircraft identification information for aircraft 102 and the version number and AIRAC cycle of NavDB 110.

Flight data analysis module 154 is configured to perform flight data analysis of routes flown by aircrafts. Flight data analysis module 154 may perform lateral flight data analysis and route-related data analysis of aircrafts and routes flown by aircrafts to analyze fuel efficiency, operational safety, regulatory compliance, and performance of aircrafts. Examples of such flight data analysis include SID/STAR analysis, runway detection analysis, RNP analysis, and/or analysis of shortcut FPLNs.

Flight data analysis module 154 may receive or otherwise obtain flight data corresponding to one or more routes flown by an aircraft and may analyze the flight data to perform flight data analysis of the one or more routes flown by the aircraft. In some examples, a computing device (not shown) may, after an aircraft has landed at the end of flying a route, download the flight recording of the route flown by the aircraft, and the computing device may send the downloaded flight recording to flight data analysis module 154 (e.g., via a network such as network 130). Such a flight recording of the route may be or include flight data corresponding to the route flown by the aircraft.

In the example of FIG. 1, flight data analysis module 154 is configured to perform flight data analysis of a route flown by aircraft 102. To perform flight data analysis of a route flown by aircraft 102, flight data analysis module 154 may receive flight recording 114 corresponding to the route flown by aircraft 102 and may analyze the flight data corresponding to the route flown by aircraft 102 contained in flight recording 114.

To perform flight data analysis of a route flown by aircraft 102, flight data analysis module 154 may use a NavDB that matches NavDB 110 used by aircraft 102 when flying the route that is to be analyzed by flight data analysis module 154. Flight data analysis module 154 may determine that a NavDB matches NavDB 110 if the NavDB is associated with version information (e.g., a version number and an AIRAC cycle) that matches the version information associated with NavDB 110. Flight data analysis module 154 may use the aircraft identification information of aircraft 102 to retrieve, from flight data storage 156, the version information of NavDB 110 associated with the aircraft identification information of aircraft 102.

Flight data analysis module 154 may use the version information of NavDB 110 to determine a NavDB that matches NavDB 110 and may retrieve the NavDB that matches NavDB 110 from navigation database repository 170. Navigation database repository 170 may be any suitable data store or repository, such as a database, that is configured to store NavDBs 172A-172N (collectively “NavDBs 172”) used by different fleets of aircrafts across different airlines. Each of NavDBs 172 may be associated with version information, such as a version number and AIRAC cycle. In some examples, navigation database repository 170 may be a part of flight analytics system 150. In some examples, navigation database repository 170 may be included in another computing system, such as one or more desktop computers, laptop computers, mainframes, servers, cloud computing systems, etc. capable of communicating with flight analytics system 150.

Flight data analysis module 154 may use the version information of NavDB 110 obtained by navigation database synchronization service 152 to retrieve, from navigation database repository 170, a NavDB that matches NavDB 110. A NavDB that matches NavDB 110 may be a NavDB having version information that matches the version information of NavDB 110, such as a NavDB having the same version number and AIRAC cycle as the version number and AIRAC cycle of NavDB 110.

To retrieve a NavDB that matches NavDB 110, flight data analysis module 154 may query navigation database repository 170 for a NavDB that matches the version information of NavDB 110. Flight data analysis module 154 may use aircraft identification information for aircraft 102 to index into flight data storage 156 to determine the version number and AIRAC cycle associated with the aircraft identification information of aircraft 102, and may query navigation database repository 170 with the version number and AIRAC cycle of NavDB 110. Navigation database repository 170 may receive the query from flight data analysis module 154 and, in response, send, to flight data analysis module 154, a NavDB, such as NavDB 172A, having the same version number and AIRAC cycle as specified in the query, that matches NavDB 110.

Flight data analysis module 154 may therefore use NavDB 172A that matches NavDB 110 of aircraft 102 to perform flight data analysis of aircraft 102. As described above, after aircraft 102 lands, flight data analysis module 154 may also receive, from FMS 106, flight recording 114. Flight data analysis module 154 may therefore perform flight data analysis of a flight of aircraft 102 using flight recording 114 of the flight and NavDB 172A that matches NavDB 110 used on the flight of aircraft 102. As described above, such flight data analysis may include SID/STAR analysis, runway detection analysis, RNP analysis, and/or analysis of shortcut FPLNs. Flight data analysis module 154 may store the results of such flight data analysis in flight data storage 156.

Flight analytics system 150 includes flight analysis portal 158 configured to provide an interface through which users can access the flight analysis and other analytical insights provided by flight data analysis module 154. Flight analysis portal 158 may output flight analysis data that is the result of performing flight data analysis of routes flown by aircraft 102. For example, flight analysis portal 158 may output one or more dashboards that present the flight analysis data. Such dashboards may include data regarding SID/STAR analysis, runway detection analysis, RNP analysis, and/or analysis of shortcut FPLNs.

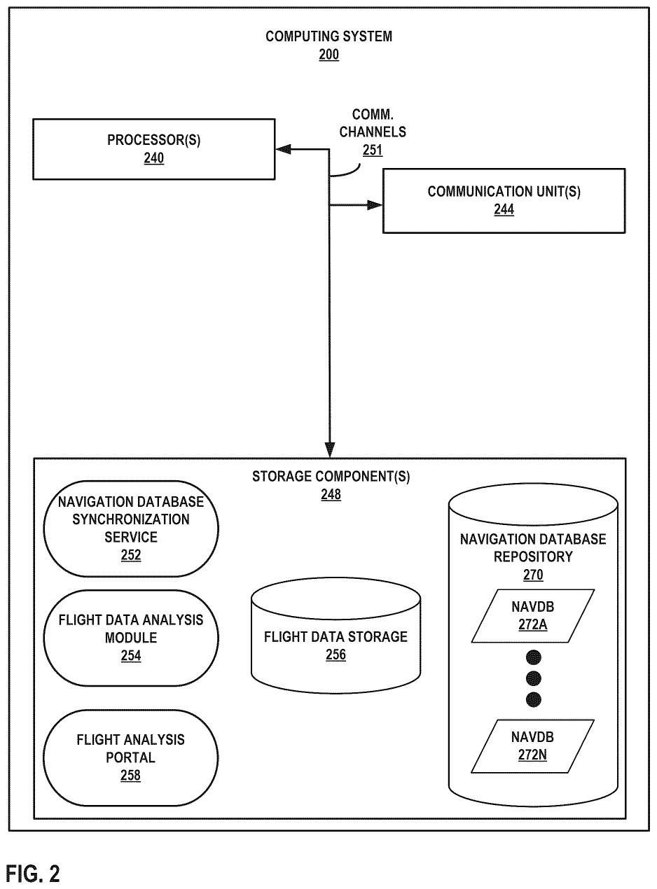

FIG. 2 is a block diagram illustrating an example computing system, in accordance with one or more aspects of the present disclosure. Computing system 200 of FIG. 2 is described below as an example of flight analytics system 150 of FIG. 1. FIG. 2 illustrates only one particular example of computing system 200, and many other examples of computing system 200 may be used in other instances and may include a subset of the components included in example computing system 200 or may include additional components not shown in FIG. 2. For example, computing system 200 may comprise a cluster of servers, and each of the servers comprising the cluster of servers making up computing system 200 may include all, or some, of the components described herein in FIG. 2, to perform the techniques disclosed herein.

As shown in the example of FIG. 2, computing system 200 includes one or more processors 240, one or more communication units 244, and one or more storage components 248. Storage components 248 include navigation database synchronization service 252, which is an example of navigation database synchronization service 152 of FIG. 1, flight data analysis module 254, which is an example of flight data analysis module 154 of FIG. 1, flight data storage 256, which is an example of flight data storage 156 of FIG. 1, flight analysis portal 258, which is an example of flight analysis portal 158 of FIG. 1, and navigation database repository 270, which is an example of navigation database repository 170 of FIG. 1.

One or more processors 240 may implement functionality and/or execute instructions associated with computing system 200. Examples of one or more processors 240 include application processors, display controllers, auxiliary processors, one or more sensor hubs, and any other hardware configure to function as a processor, a processing unit, or a processing device. Navigation database synchronization service 252, flight data analysis module 254, and flight analysis portal 258 may be operable by one or more processors 240 to perform various actions, operations, or functions of computing system 200. For example, one or more processors 240 of computing system 200 may retrieve and execute instructions stored by one or more storage components 248 that cause one or more processors 240 to perform the operations of navigation database synchronization service 252, flight data analysis module 254, and flight analysis portal 258. The instructions, when executed by one or more processors 240, may cause computing system 200 to store information within one or more storage components 248, for example, in flight data storage 256.

One or more communication units 244 of computing system 200 may communicate with external devices (e.g., airline operations and control center 120 of FIG. 1) via one or more wired and/or wireless networks by transmitting and/or receiving network signals on the one or more networks. Examples of one or more communication units 244 include a network interface card (e.g., such as an Ethernet card), an optical transceiver, a radio frequency transceiver, a global positioning satellite (GPS) receiver, or any other type of device that can send and/or receive information. Other examples of one or more communication units 244 may include short wave radios, cellular data radios, wireless network radios, as well as universal serial bus (USB) controllers.

Communication channels 251 may interconnect each of the components 240, 242, and 248 for inter-component communications (physically, communicatively, and/or operatively). In some examples, communication channels 251 may include a system bus, a network connection, an inter-process communication data structure, or any other method for communicating data.

One or more storage components 248 within computing system 200 may store information for processing during operation of computing system 200 (e.g., computing system 200 may store data accessed by navigation database synchronization service 252, flight data analysis module 254, and flight analysis portal 258 during execution at computing system 200). For example, one or more storage components 248 may store flight data storage 256 and navigation database repository 270. In some examples, one or more storage components 248 is a temporary memory, meaning that a primary purpose of one or more storage components 248 is not long-term storage. In this example, one or more storage components 248 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, one or more storage components 248 may also include one or more computer-readable storage media. One or more storage components 248, in some examples, include one or more non-transitory computer-readable storage mediums. One or more storage components 248 may be configured to store larger amounts of information than typically stored by volatile memory. One or more storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage components 248 may store program instructions and/or information (e.g., data) associated with navigation database synchronization service 252, flight data analysis module 254, and flight analysis portal 258. Storage components 248 may include a memory configured to store data or other information associated with navigation database synchronization service 252, flight data analysis module 254, flight data storage 256, flight analysis portal 258, and navigation database repository 270.

One or more processors 240 is configured to execute navigation database synchronization service 252 to determine the navigational databases (NavDBs) used by aircrafts to fly one or more routes. Navigation database synchronization service 152 may communicate with an airline operations and control center, such as airline operations and control center 120 of FIG. 1, that monitors for and receives downlink messages (e.g., downlink message 118 of FIG. 1) from aircrafts that indicate the version information of NavDBs used by the aircrafts, and navigation database synchronization service 152 may obtain the version information of NavDBs used by the aircrafts from the airline operations and control center.

For example, navigation database synchronization service 252 may communicate, via one or more communication units 244, with an airline operations and control center that may receive, from an aircraft that is in-flight flying a route, a downlink message that specifies the version information of the NavDB used by the aircraft to fly the route. In some examples, the downlink message may also include aircraft identification information for the aircraft that sent the downlink message, such as an aircraft registration number (also referred to as a tail number) of the aircraft.

Navigation database synchronization service 252 may receive, from the airline operations and control center the version information of the NavDB used by the aircraft to fly one or more routes and aircraft identification information of the aircraft. The version information of the NavDB may include the version number of the NavDB and the AIRAC cycle of the NavDB.

Navigation database synchronization service 252 may store an association of the version information of the NavDB used by an aircraft and the aircraft identification information of the aircraft in flight data storage 256. For example, navigation database synchronization service 252 may store, in flight data storage 256, the aircraft identification information of the aircraft, such as a tail number of the aircraft, the version number of the NavDB used by the aircraft, and the AIRAC cycle of the NavDB used by the aircraft. In this way, flight data storage 256 may therefore be able to store, for each of a plurality of aircrafts for which flight data analysis module 254 may perform flight data analysis. Applications and processes running on computing system 200, such as flight data analysis module 254, may therefore index into flight data storage 256 using the aircraft identification information of an aircraft to retrieve, from flight data storage 256 the associated version information (e.g., the version number and AIRAC cycle) of the NavDB used by the aircraft.

One or more processors 240 is configured to execute flight data analysis module 254 to perform flight data analysis of route flown by aircrafts. Flight data analysis module 254 may perform lateral flight data analysis and route-related data analysis of aircrafts and routes flown by aircrafts. Flight data analysis module 254 may perform such flight data analysis to analyze fuel efficiency, operational safety, regulatory compliance, and performance of aircrafts. Examples of such flight data analysis include SID/STAR analysis, runway detection analysis, RNP analysis, and/or analysis of shortcut FPLNs.

To perform flight data analysis of a route flown by an aircraft, flight data analysis module 254 may obtain flight data corresponding to the route flown by the aircraft. The flight data may include flight data recorded by a flight recorder of the aircraft while the aircraft flies the route that is to be analyzes. In some examples, flight data may be a quick access recorder (QAR) flight data, and the flight data may be in an ARINC 400 series format, such as ARINC 429, or an ARINC 700 series format, such as ARINC 702, 717, or 767. The flight data may include parameters and associated values. Examples of such parameters may include airspeed, altitude, engine revolutions per minute (RPM), temperature, heading, pitch, roll, vertical speed, cabin pressure, fuel flow, and numerous other potential parameters.

Flight data analysis module 254 may obtain the flight data corresponding to the route flown by the aircraft in any suitable manner. In some examples, a computing device may download, from the aircraft's flight recorder, the flight data corresponding to the route flown by the aircraft, and flight data analysis module 254 may receive (e.g., from the computing device or from another computing system), the downloaded flight data corresponding to the route flown by the aircraft and the aircraft identification information of the aircraft.

To perform flight data analysis of a route flown by an aircraft that uses a first NavDB when flying the route, flight data analysis module 254 may use a second NavDB that matches the first NavDB used by the aircraft to perform the flight analysis. Two NavDBs may match when the two NavDBs are associated with the same version information, such as by being associated with the same version number and the same AIRAC cycle.

Flight data analysis module 254 may determine the first NavDB used by an aircraft when flying a route based on the aircraft identification information of the aircraft. Flight data analysis module 254 may use the aircraft identification information of the aircraft to index into flight data storage 256 to retrieve the version information of the first NavDB associated with the aircraft identification information of the aircraft. For example, flight data analysis module 254 may use the aircraft identification information of the aircraft to retrieve the version number and the AIRAC cycle of the first NavDB associated with the aircraft identification information of the aircraft.

Flight data analysis module 254 may retrieve, using the version information of the first NavDB used by an aircraft when flying a route that is to be analyzed, from navigation database repository 270, a second NavDB that matches the first NavDB. Navigation database repository 270 may be any suitable data store or repository, such as a database, that may be included in computing system 200 or may be included in an external system. Navigation database repository 270 may store NavDBs 272A-272N (collectively “NavDBs 272”), which are examples of NavDBs 172 of FIG. 1, used by different fleets of aircrafts across different airlines. Each of NavDBs 272 may be associated with version information, such as a version number and AIRAC cycle.

To retrieve a second NavDB that matches the first NavDB used by the aircraft when flying a route that is to be analyzed, flight data analysis module 254 may query navigation database repository 270 for a second NavDB that matches the version information of the first NavDB. Flight data analysis module 154 may query navigation database repository 270 with the version number and AIRAC cycle of the first DB and may, in response, retrieve a second NavDB, such as NavDB 272A, having the same version number and AIRAC cycle as the first NavDB.

Flight data analysis module 254 may therefore use NavDB 272A to perform flight data analysis of a route flown by the first aircraft. That is, flight data analysis module 254 may perform flight data analysis of flight data corresponding to the route flown by the aircraft using NavDB 272A. As described above, such flight data analysis may include SID/STAR analysis, runway detection analysis, RNP analysis, and/or analysis of shortcut FPLNs. Flight data analysis module 254 may perform such flight data analysis of flight data corresponding to the route flown by the aircraft using NavDB 272A to generate flight analytics data associated with the route flown by the aircraft, which is the result of such flight analysis, and may store the flight analytics data associated with the route flown by the aircraft in flight data storage 256.

One or more processors 240 are configured to execute flight analysis portal 258 to provide an interface through which users can access the flight analysis, such as the flight analytics data associated with the route flown by the aircraft, and other analytical insights provided by flight data analysis module 254. Flight analysis portal 258 may be in the form of one or more websites and/or web pages that can be accessed by computing devices to access the flight analytics data.

Flight analysis portal 158 may output the flight analytics data associated with the route flown by the aircraft. For example, flight analysis portal 158 may output, for display at computing devices connected to computing system 200, one or more dashboards that present the flight analytics data. Such dashboards may include data regarding SID/STAR analysis, runway detection analysis, RNP analysis, and/or analysis of shortcut FPLNs for the route flown by the aircraft. Such dashboards may provide visualizations and data regarding route efficiency analysis, fuel efficiency analysis, adherence to air traffic control procedures, performance monitoring, weather and environmental impacts, airspace compliance, maintenance and system health analysis, environmental compliance, historical flight comparison with the same route flown by the same or other aircrafts, and the like.

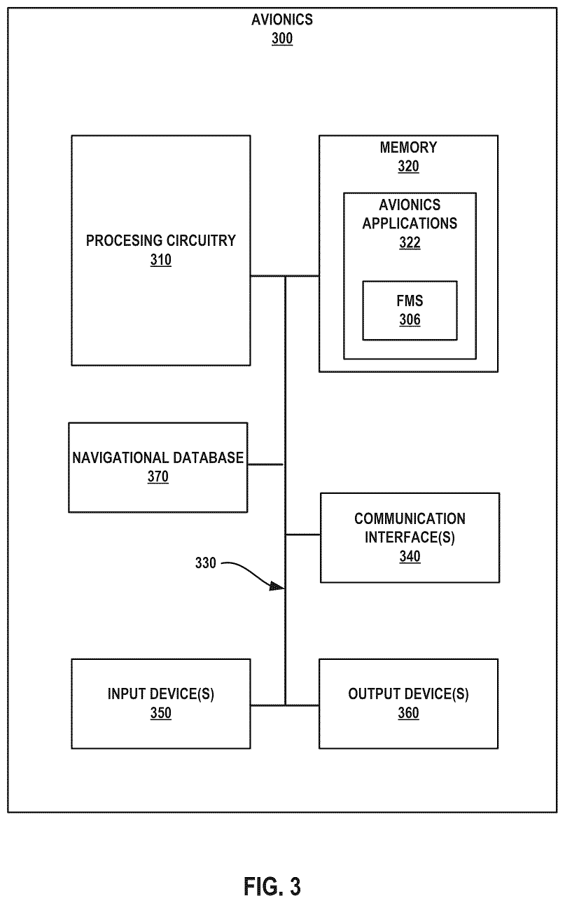

FIG. 3 is a block diagram illustrating an example avionics system, in accordance with one or more aspects of the present disclosure. Avionics 300 is described below as an example implementation of avionics 104 described above. In the example of FIG. 3, avionics 300 includes processing circuitry 310, memory 320 which stores avionics applications 322, communication interface(s) 340 to communicate with other devices, such as airline operations and control center 120, input device(s) 350, output device(s) 360, and navigational database 370. The aforementioned components of avionics 300 may be connected to one another through a bus 330, which generally represents one or more busses and is intended to generically represent all the electrical and data connectivity of internal components included within avionics 300.

Processing circuitry 310 implements the functionality of and/or executes the instructions associated with avionics applications 322. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 300 may store instructions for the software in a suitable, non-transitory computer-readable medium (e.g., memory 320) and execute the instructions in hardware using processing circuitry 310 to perform the techniques of this disclosure.

Memory 320 is intended to generically represent all memory included within avionics 300. In some implementations, memory 320 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 3 as avionics applications 322) may be stored in any volatile and/or non-volatile memory component of memory 320.

Communication interface(s) 340 generally represents all hardware within avionics 300 for communicating with external devices either on the ground or while in flight. Communication interface(s) 340 may facilitate communication with external devices via one or more wired and/or wireless network connections by transmitting and/or receiving signals on the one or more networks. Examples of communication interface(s) 340 include a network interface card (e.g. such as an Ethernet card), an optical transceiver, a radio frequency transceiver, a GPS receiver, or any other type of device that can send and/or receive information. Other examples of communication interface(s) 340 may include short wave radios, cellular data radios, wireless network radios, as well as universal serial bus (USB) controllers. Examples of communication interface(s) 340 for in-flight communication include a very high frequency (VHF) radio, a high frequency (HF) radio, or a satellite communication (SATCOM) radio. Examples of communication interface(s) 340 used for data links include an ACARS for providing a digital data link system that allows for the exchange of messages between the aircraft and ground stations for purposes such as flight plan updates, weather information, maintenance reports, and transmission of NavDB version information. Another examples of communication interface(s) 340 used for data links include controller-pilot data link communications (CPDLC) which allows air traffic control to send instructions and receive acknowledgments from pilots via text messages.

Communications interface(s) 340 may also include an automatic dependent surveillance-broadcast transponder. The various examples of communications interfaces listed above represent a non-exhaustive list of the types of the types of communication interfaces that may be included in communication interface(s) 340.

Avionics 300 also includes input device(s) 350 and output device(s) 360. Examples of input device(s) 350 include control display units (CDUs) with alphanumeric keypads or touchscreens to enter flight plans, waypoints, and other necessary data. Input device(s) 350 may also include an FMS control panel for entering information to the FMS, such as route, altitude, and speed using dedicated buttons, knobs, and touchscreen interfaces. Input device(s) 350 may also include yoke or sidestick controls as well as touchscreen interfaces. Input device(s) 350 may also include rotary knobs for setting values for altitudes, speeds, and other parameters and toggle switches for selecting modes or turning systems on and off.

Examples of output device(s) 360 may include an electronic flight instrument display to provide visual representations of flight data, including altitude, airspeed, heading, and attitude. Output device(s) 360 may also include a Heads-Up Display (HUD) that projects critical flight information onto a transparent screen in the pilot's line of sight or other cockpit displays to show navigation maps, engine parameters, system statuses, and the like. Output device(s) 360 may also include engine instrumentation displays to display data on engine performance, such as temperature, pressure, and revolutions per minute (RPMs). Output device(s) 360 may also include audio panels to relay communication from radios and alerts from systems to the cockpit. Output device(s) 360 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 350 and output device(s) 360. Additionally, input and output functionality of avionics 300 may facilitated by external devices that are separate from input device(s) 350 and output device(s) 360.

Avionics applications 322 represent a suite of software tools that may be used by a pilot in managing flight operations. Avionics applications 322 includes FMS 306, which is an example of FMS 106 discussed above, as well as other applications for communication, navigation, and monitoring within an aircraft.

Navigational database 370 is an example of NavDB 110 discussed above and represents a specialized database that stores information needed by FMS 306 for the navigation and operation of an aircraft for purposes such as flight planning, route management, and ensuring safe navigation throughout a flight. Navigational database 370 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 370 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 370 may be regularly updated to reflect changes in air traffic regulations, airport information, and navigational aids to ensure pilots have current information for safe and efficient flight operations.

Although not explicitly shown in FIG. 3, avionics 300 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 300 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

In accordance with aspects of this disclosure, processing circuitry 310 may execute FMS 306 to determine that FMS 306 has been updated with a new version of navigational database 370. For example, FMS 306 may determine the version information of navigational database 370 (e.g., the version number and the AIRAC cycle of the navigational database 370) in FMS 306 that is currently being used by FMS 306, and may compare the version information of navigational database 370 with the persisted version information of the NavDB that was in use prior to the current flight to determine whether FMS 306 has been updated with a new version of a navigational database.

Processing circuitry 310 is configured to execute FMS 306 to, in response to determining that FMS 306 has been updated with a newer version of a navigational database, in the form of navigational database 370, determine to send, to a ground communication station, a downlink message that specifies the version information of navigational database 370. Processing circuitry 310 is configured to execute FMS 306 to, in response to the aircraft containing avionics 300 being within communication range of a ground communication station, such as airline operations and control center 120, send, via communication interface(s) 340, a downlink message (e.g., downlink message 118 described above) to the ground communication station. The downlink message may specify the version information of navigational database 370. As discussed above, the version information of navigational database 370 include a version number and an AIRAC cycle. In some examples, the downlink message may also specify aircraft identification information for the aircraft containing avionics 300, such as an aircraft registration number (also referred to as a tail number) of the aircraft.

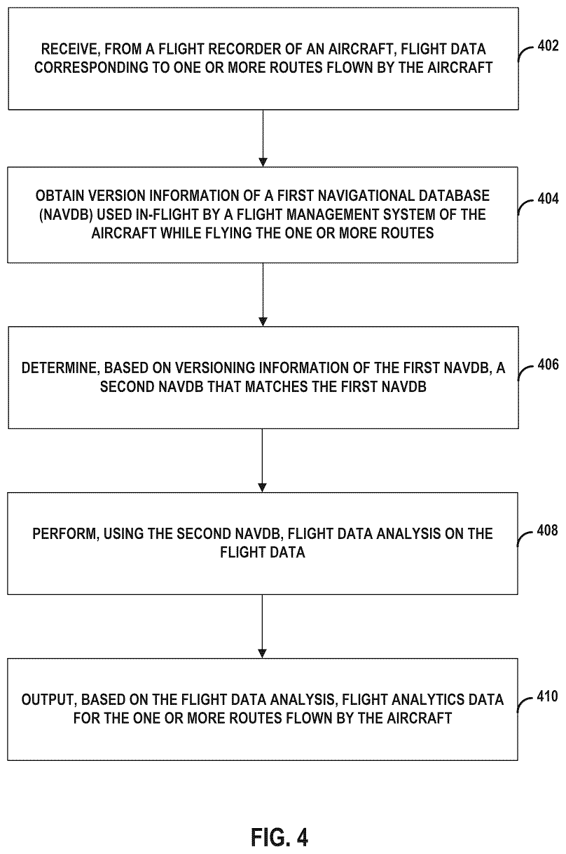

FIG. 4 is a flowchart illustrating example operations performed by an example flight analytics system, in accordance with one or more aspects of the present disclosure. FIG. 4 is described below in the context of FIGS. 1 and 2.

As shown in FIG. 4, flight analytics system 150 may receive, from a flight recorder 112 of an aircraft 102, flight data corresponding to one or more routes flown by the aircraft 102 (402).

Flight analytics system 150 may obtain, based on a downlink message 118 sent by the aircraft 102 in-flight, version information of a first navigation database (NavDB) 110 used in-flight by FMS 106 of the aircraft 102 while flying the one or more routes (404). In some examples, the version information of the first NavDB 110 includes a version number associated with the first NavDB 110 and an AIRAC cycle associated with the first NavDB 110.

In some examples, wherein to obtain the version information of the first NavDB 110, flight analytics system 150 may obtain, from a ground communication station that receives, while the aircraft 102 is flying the one or more routes, the downlink message 118 that specifies the version information of the first NavDB 110. In some examples, the ground communication station is an airline operations and control center 120.

Flight analytics system 150 may determine, based on the version information of the first NavDB 110, a second NavDB 172A that matches the first NavDB 110 (406). In some examples, to determine the second NavDB 172A that matches the first NavDB 110, the flight analytics system 150 may query a navigation database repository 170 for a NavDB stored by the navigation database repository 170 that matches the version number associated with the first NavDB 110 and the AIRAC cycle associated with the first NavDB 110. Flight analytics system 150 may, in response to querying the navigation database repository 170, receive, from the navigation database repository 170, the second NavDB 172A, that matches the first NavDB 110. In some examples, a version number associated with the second NavDB 172A matches the version number associated with the first NavDB 110 and an AIRAC cycle associated with the second NavDB 172A matches the AIRAC cycle associated with the first NavDB 110.

Flight analytics system 150 may perform, using the second NavDB 172A, flight data analysis on the flight data (408). In some examples, the flight data analysis includes one or more of: Standard Instrument Departure/Standard Terminal Arrival Routes (SID/STAR) analysis, runway detection analysis, Required Navigation Performance (RNP) analysis, or analysis of shortcut flight plans (FPLNs).

Flight analytics system 150 may output, based on the flight data analysis, flight analytics data for the one or more routes flown by the aircraft 102 (410).

Aspects of this disclosure include the following clauses.

Clause 1. A computer-implemented method comprising: receiving, from a flight recorder of an aircraft and by a computing device executing a flight analytics system, flight data corresponding to one or more routes flown by the aircraft; obtaining, by the computing device executing the flight analytics system and based on a downlink message sent by the aircraft in-flight, version information of a first navigation database (NavDB) used in-flight by a flight management system of the aircraft while flying the one or more routes; determining, by the computing device executing the flight analytics system and based on the version information of the first NavDB, a second NavDB that matches the first NavDB; performing, by the computing device executing the flight analytics system and using the second NavDB, flight data analysis on the flight data; and outputting, by the computing device executing the flight analytics system and based on the flight data analysis, flight analytics data for the one or more routes flown by the aircraft.

Clause 2. The method of clause 1, wherein the version information of the first NavDB includes a version number associated with the first NavDB and an Aeronautical Information Regulation And Control (AIRAC) cycle associated with the first NavDB.

Clause 3. The method of clause 2, wherein determining the second NavDB that matches the first NavDB further comprises: querying, by the computing device executing the flight analytics system, a navigation database repository for a NavDB stored by the navigation database repository that matches the version number associated with the first NavDB and the AIRAC cycle associated with the first NavDB; and in response to querying the navigation database repository, receiving, by the computing device executing the flight analytics system and from the navigation database repository, the second NavDB, that matches the first NavDB.

Clause 4. The method of any of clauses 2 and 3, wherein a version number associated with the second NavDB matches the version number associated with the first NavDB and an AIRAC cycle associated with the second NavDB matches the AIRAC cycle associated with the first NavDB.

Clause 5. The method of any of clauses 1-4, wherein obtaining the version information of the first NavDB further comprises: obtaining, by the computing device executing the flight analytics system and from a ground communication station that receives, while the aircraft is flying the one or more routes, the downlink message that specifies the version information of the first NavDB.

Clause 6. The method of clause 5, wherein the ground communication station is an airline operations and control center.

Clause 7. The method of any of clauses 1-6, wherein the flight data analysis comprises one or more of: Standard Instrument Departure/Standard Terminal Arrival Routes (SID/STAR) analysis, runway detection analysis, Required Navigation Performance (RNP) analysis, or analysis of shortcut flight plans (FPLNs).

Clause 8. A computing system comprising: memory; and one or more processors communicably coupled to the memory and configured to: receive, from a flight recorder of an aircraft, flight data corresponding to one or more routes flown by the aircraft; obtain, based on a downlink message sent by the aircraft in-flight, version information of a first navigation database (NavDB) used in-flight by a flight management system of the aircraft while flying the one or more routes; determine, based on the version information of the first NavDB, a second NavDB that matches the first NavDB; perform, using the second NavDB, flight data analysis on the flight data; and output, based on the flight data analysis, flight analytics data for the one or more routes flown by the aircraft.

Clause 9. The computing system of clause 8, wherein the version information of the first NavDB includes a version number associated with the first NavDB and an Aeronautical Information Regulation And Control (AIRAC) cycle associated with the first NavDB.

Clause 10. The computing system of clause 9, wherein to determine the second NavDB that matches the first NavDB, the one or more processors are further configured to: query a navigation database repository for a NavDB stored by the navigation database repository that matches the version number associated with the first NavDB and the AIRAC cycle associated with the first NavDB; and in response to querying the navigation database repository, receive, from the navigation database repository, the second NavDB, that matches the first NavDB.

Clause 11. The computing system of any of clauses 9 and 10, wherein a version number associated with the second NavDB matches the version number associated with the first NavDB and an AIRAC cycle associated with the second NavDB matches the AIRAC cycle associated with the first NavDB.

Clause 12. The computing system of any of clauses 8-11, wherein to obtain the version information of the first NavDB, the one or more processors are further configured to: obtain, from a ground communication station that receives, while the aircraft is flying the one or more routes, the downlink message that specifies the version information of the first NavDB.

Clause 13. The computing system of clause 12, wherein the ground communication station is an airline operations and control center.

Clause 14. The computing system of any of clauses 8-13, wherein the flight data analysis comprises one or more of: Standard Instrument Departure/Standard Terminal Arrival Routes (SID/STAR) analysis, runway detection analysis, Required Navigation Performance (RNP) analysis, or analysis of shortcut flight plans (FPLNs).

Clause 15. A non-transitory computer-readable storage medium comprising instructions, that when executed by one or more processors of a computing system, cause the one or more processors to: receive, from a flight recorder of an aircraft, flight data corresponding to one or more routes flown by the aircraft; obtain, based on a downlink message sent by the aircraft in-flight, version information of a first navigation database (NavDB) used in-flight by a flight management system of the aircraft while flying the one or more routes; determine, based on the version information of the first NavDB, a second NavDB that matches the first NavDB; perform, using the second NavDB, flight data analysis on the flight data; and output, based on the flight data analysis, flight analytics data for the one or more routes flown by the aircraft.

Clause 16. The non-transitory computer-readable storage medium of clause 15, wherein the version information of the first NavDB includes a version number associated with the first NavDB and an Aeronautical Information Regulation And Control (AIRAC) cycle associated with the first NavDB.

Clause 17. The non-transitory computer-readable storage medium of clause 16, wherein the instructions that cause the one or more processors to determine the second NavDB that matches the first NavDB further cause the one or more processors to: query a navigation database repository for a NavDB stored by the navigation database repository that matches the version number associated with the first NavDB and the AIRAC cycle associated with the first NavDB; and in response to querying the navigation database repository, receive, from the navigation database repository, the second NavDB, that matches the first NavDB.

Clause 18. The non-transitory computer-readable storage medium of any of clauses 16 and 17, wherein a version number associated with the second NavDB matches the version number associated with the first NavDB and an AIRAC cycle associated with the second NavDB matches the AIRAC cycle associated with the first NavDB.

Clause 19. The non-transitory computer-readable storage medium of any of clauses 15-18, wherein the instructions that cause the one or more processors to obtain the version information of the first NavDB further cause the one or more processors to: obtain, from a ground communication station that receives, while the aircraft is flying the one or more routes, the downlink message that specifies the version information of the first NavDB.

Clause 20. The non-transitory computer-readable storage medium of clause 19, wherein the ground communication station is an airline operations and control center.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while disks reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A computer-implemented method comprising:
receiving, from a flight recorder of an aircraft and by a computing device executing a flight analytics system, flight data corresponding to one or more routes flown by the aircraft;
obtaining, by the computing device executing the flight analytics system and based on a downlink message sent by the aircraft while in-flight, version information of a first navigation database (NavDB) used in-flight by a flight management system of the aircraft while flying the one or more routes;
determining, by the computing device executing the flight analytics system and based on the version information of the first NavDB, a second NavDB that matches the first NavDB;
performing, by the computing device executing the flight analytics system and using the second NavDB, flight data analysis on the flight data; and
outputting, by the computing device executing the flight analytics system and based on the flight data analysis, flight analytics data for the one or more routes flown by the aircraft.

2. The method of claim 1, wherein the version information of the first NavDB includes a version number associated with the first NavDB and an Aeronautical Information Regulation And Control (AIRAC) cycle associated with the first NavDB.

3. The method of claim 2, wherein determining the second NavDB that matches the first NavDB further comprises:
querying, by the computing device executing the flight analytics system, a navigation database repository for a NavDB stored by the navigation database repository that matches the version number associated with the first NavDB and the AIRAC cycle associated with the first NavDB; and
in response to querying the navigation database repository, receiving, by the computing device executing the flight analytics system and from the navigation database repository, the second NavDB, that matches the first NavDB.

4. The method of claim 2, wherein a version number associated with the second NavDB matches the version number associated with the first NavDB and an AIRAC cycle associated with the second NavDB matches the AIRAC cycle associated with the first NavDB.

5. The method of claim 1, wherein obtaining the version information of the first NavDB further comprises:
obtaining, by the computing device executing the flight analytics system and from a ground communication station that receives, while the aircraft is flying the one or more routes, the downlink message that specifies the version information of the first NavDB.

6. The method of claim 5, wherein the ground communication station is an airline operations and control center.

7. The method of claim 1, wherein the flight data analysis comprises one or more of:
Standard Instrument Departure/Standard Terminal Arrival Routes (SID/STAR) analysis, runway detection analysis, Required Navigation Performance (RNP) analysis, or analysis of shortcut flight plans (FPLNs).

8. A computing system comprising:
memory; and
one or more processors communicably coupled to the memory and configured to:
receive, from a flight recorder of an aircraft, flight data corresponding to one or more routes flown by the aircraft;
obtain, based on a downlink message sent by the aircraft while in-flight, version information of a first navigation database (NavDB) used in-flight by a flight management system of the aircraft while flying the one or more routes;
determine, based on the version information of the first NavDB, a second NavDB that matches the first NavDB;
perform, using the second NavDB, flight data analysis on the flight data; and
output, based on the flight data analysis, flight analytics data for the one or more routes flown by the aircraft.

9. The computing system of claim 8, wherein the version information of the first NavDB includes a version number associated with the first NavDB and an Aeronautical Information Regulation And Control (AIRAC) cycle associated with the first NavDB.

10. The computing system of claim 9, wherein to determine the second NavDB that matches the first NavDB, the one or more processors are further configured to:
query a navigation database repository for a NavDB stored by the navigation database repository that matches the version number associated with the first NavDB and the AIRAC cycle associated with the first NavDB; and
in response to querying the navigation database repository, receive, from the navigation database repository, the second NavDB, that matches the first NavDB.

11. The computing system of claim 9, wherein a version number associated with the second NavDB matches the version number associated with the first NavDB and an AIRAC cycle associated with the second NavDB matches the AIRAC cycle associated with the first NavDB.

12. The computing system of claim 8, wherein to obtain the version information of the first NavDB, the one or more processors are further configured to:
obtain, from a ground communication station that receives, while the aircraft is flying the one or more routes, the downlink message that specifies the version information of the first NavDB.

13. The computing system of claim 12, wherein the ground communication station is an airline operations and control center.

14. The computing system of claim 8, wherein the flight data analysis comprises one or more of: Standard Instrument Departure/Standard Terminal Arrival Routes (SID/STAR) analysis, runway detection analysis, Required Navigation Performance (RNP) analysis, or analysis of shortcut flight plans (FPLNs).

15. A non-transitory computer-readable storage medium comprising instructions, that when executed by one or more processors of a computing system, cause the one or more processors to:
receive, from a flight recorder of an aircraft, flight data corresponding to one or more routes flown by the aircraft;
obtain, based on a downlink message sent by the aircraft while in-flight, version information of a first navigation database (NavDB) used in-flight by a flight management system of the aircraft while flying the one or more routes;
determine, based on the version information of the first NavDB, a second NavDB that matches the first NavDB;
perform, using the second NavDB, flight data analysis on the flight data; and
output, based on the flight data analysis, flight analytics data for the one or more routes flown by the aircraft.

16. The non-transitory computer-readable storage medium of claim 15, wherein the version information of the first NavDB includes a version number associated with the first NavDB and an Aeronautical Information Regulation And Control (AIRAC) cycle associated with the first NavDB.

17. The non-transitory computer-readable storage medium of claim 16, wherein the instructions that cause the one or more processors to determine the second NavDB that matches the first NavDB further cause the one or more processors to:
query a navigation database repository for a NavDB stored by the navigation database repository that matches the version number associated with the first NavDB and the AIRAC cycle associated with the first NavDB; and
in response to querying the navigation database repository, receive, from the navigation database repository, the second NavDB, that matches the first NavDB.

18. The non-transitory computer-readable storage medium of claim 16, wherein a version number associated with the second NavDB matches the version number associated with the first NavDB and an AIRAC cycle associated with the second NavDB matches the AIRAC cycle associated with the first NavDB.

19. The non-transitory computer-readable storage medium of claim 15, wherein the instructions that cause the one or more processors to obtain the version information of the first NavDB further cause the one or more processors to:
obtain, from a ground communication station that receives, while the aircraft is flying the one or more routes, the downlink message that specifies the version information of the first NavDB.

20. The non-transitory computer-readable storage medium of claim 19, wherein the ground communication station is an airline operations and control center.
